(19) United States
(12) Patent Application Publication
(10) Pub. No.: US 2019/0009135 A1
(43) Pub. Date: Jan. 10, 2019

(54) MOBILE EXERCISE APPARATUS CONTROLLER AND INFORMATION TRANSMISSION COLLECTION DEVICE COUPLED TO EXERCISE APPARATUS AND EXERCISE APPARATUS AND CONTROL METHOD

(71) Applicant: Manifold Health Tech, Inc., Grand Cayman (KY)

(72) Inventor: Bo-Ru Wu, Grand Cayman (KY)

(21) Appl. No.: 15/645,219

(22) Filed: Jul. 10, 2017

(51) Int. Cl. A63B 24/00; A63B 71/06; G06F 17/30

(52) U.S. Cl. CPC A63B 24/0075; A63B 24/0087; A63B 71/0622; G06K 7/1095; A63B 2071/063; A63B 2071/065; G06F 17/30879

(57) ABSTRACT

An exercise apparatus control method is provided. A coach user transmits a control parameter to a cloud host via the Internet. An operator uses a mobile exercise apparatus controller to download a corresponding control parameter of the exercise apparatus via the Internet and transmits it to the exercise apparatus for setting. After the user completes the operation, the relevant recorded data during use is transmitted back to the cloud host for the coach user to confirm the data. The coach can directly instruct the trainee to use the corresponding apparatus and carry out the corresponding condition setting. The trainee only follows the instructions to use the exercise apparatus. The exercise apparatus reads the set parameter for operation, enhancing the instruction efficiency of the coach and the leaning convenience of the trainee.

### FIELD OF THE INVENTION

The present invention relates to a control method for an exercise apparatus and belongs to the technical field of an exercise apparatus, and more particularly to a method and a device for a coach to upload a required parameter of using the exercise apparatus to a cloud host, and then a user downloads the parameter through a mobile exercise apparatus controller for operating the exercise apparatus.

### BACKGROUND OF THE INVENTION

The importance of exercise to the health is not much to explain. However, most people are unable to develop a regular and effective exercise habit due to the changeable circumstances of the daily routine, outdoor climate factors and other reasons. In order to develop a good exercise habit, many people use exercise machines at home or at the gym to exclude the factors of the weather and the time.

The use of exercise machines not only requires a user to put into use but also requires the guidance and recommendations step by step of a professional coach to improve its training intensity and mode in order to achieve the best training effectiveness. However, the fee for a fitness coach (a private coach or a coach at the gym) is high, and it is necessary to book the time in advance. For busy modern people, this is less flexible and cannot be trained at any time. Although there are coaching courses for teaching by means of videos, there is still no customized training program for the individual status of each user in accordance with the use parameters and modes of the exercise machine. The user (trainee) has to operate the exercise machine himself/herself, which cannot ensure that the user's settings are correct.

Accordingly, the present invention is to provide a control method for an exercise apparatus and a mobile exercise apparatus controller for a user at a far end to obtain a customized training program. Through the present invention, the user can obtain a professional fitness program and the set parameters of the corresponding exercise machine. It is more flexible for using time to overcome the problems of the prior art.

### SUMMARY OF THE INVENTION

The primary object of the present invention is to provide a mobile exercise apparatus controller and a method thereof, allowing a user to get a customized fitness program.

The mobile exercise apparatus controller of the present invention is communicated with a cloud host for receiving the data of the cloud host. The mobile exercise apparatus controller comprises a display module, an arithmetic processing device, an information retrieval device, and a wireless receiving device.

According to one aspect of the present invention, an exercise apparatus control method is provided. A mobile exercise apparatus controller is provided to communicate with a cloud host via the Internet. The mobile exercise apparatus controller obtains an exercise apparatus control parameter set in the cloud host and transmit it to an exercise apparatus for performing a corresponding setting operation. The method comprises an exercise apparatus control parameter setting step, an exercise apparatus control parameter obtaining step, a control parameter displaying step, and a bar code reading step.

In the exercise apparatus control parameter setting step, a coach user transmits a control parameter to the cloud host via the Internet. In the exercise apparatus control parameter obtaining step, an operator uses the mobile exercise apparatus controller to communicate with the cloud host and download the corresponding control parameter via the Internet. In the control parameter displaying step, the mobile exercise apparatus controller converts the obtained control parameter into a bar code and displays it on a display module of the mobile exercise apparatus controller. In the bar code reading step, an information transmission collection device coupled to or communicated with the exercise apparatus performs reading. After reading, the control parameter is displayed on a display unit connected with the information transmission collection device or transmitted to the exercise apparatus for performing a setting according to the control parameter.

The exercise apparatus control method may further comprise an information collecting step and an information return step. In the information collecting step, the information transmission collection device coupled to the exercise apparatus obtains or receives the operation data of the exercise apparatus, and then the operation data is converted into a bar code and displayed on a display unit connected with the information transmission collection device of the exercise apparatus. In the information return step, an information retrieval device connected with the mobile exercise apparatus controller performs data reading, and the data is transmitted back to the cloud host.

A designated user (for example, a coach) uploads the corresponding parameter to the cloud host, and the user can download the corresponding parameter data via the mobile exercise apparatus controller, and the exercise apparatus control parameter is converted into a data format (such as, a two-dimensional bar code, a QR code, or other format able to complete data transmission via image recognition) through the arithmetic processing device, and an information transmission collection device coupled to the exercise apparatus performs reading confirmation. The set parameter is transmitted to the exercise apparatus for performing setting or exercise. After the exercise apparatus is used, the data is returned to the mobile exercise apparatus controller and then uploaded to the cloud host, thereby forming a communication platform between the coach and the trainee. The trainee only needs to use the exercise apparatus according to the instructions and perform operations after reading the set parameter. This greatly reduces the burden of the trainee to operate the exercise apparatus and improves the efficiency of use. Further, through the signal transmission of the information transmission collection device and the mobile exercise apparatus controller, it is possible to confirm whether or not the exercise apparatus operated by the user is the target apparatus. If the information transmission collection device confirms that it is not the corresponding apparatus after reading, it will send a warning to the user to prevent the user from using the apparatus wrongly. The warning may be a display of the display unit or a sound from a connected sounding device.

For different body trainings, the exercise apparatus is not limited to what kind of exercise machines, which may be a treadmill, an elliptical training machine, an exercise bike, a flywheel exercise pedaling machine, and the like.

Through the above-mentioned mobile exercise apparatus controller and the corresponding exercise apparatus, the coach can set the parameter before exercise through the cloud host according to the user's individual status and training needs. After the completion of training, the coach can receive and understand the user's training status to assess and plan the next training through the return information.

### BRIEF DESCRIPTION OF THE DRAWINGS

FIG. 1 is a schematic view of the mobile exercise apparatus controller in accordance with an embodiment of the present invention;

FIG. 2 is a flow chart of the control method in accordance with an embodiment of the present invention;

FIG. 3 is a flow chart of using the mobile exercise apparatus controller in accordance with an embodiment of the present invention;

FIG. 4 is a schematic view of the mobile exercise apparatus controller communicated with the exercise apparatus in accordance with an embodiment of the present invention; and

FIG. 5 is a flow chart of the mobile exercise apparatus controller communicated with the information transmission collection device in accordance with an embodiment of the present invention.

### DETAILED DESCRIPTION OF THE PREFERRED EMBODIMENTS

Embodiments of a mobile exercise apparatus controller and a control method of the present invention will now be described with reference to the accompanying drawings. For the embodiments to be understood more easily, the following description combines a method process and an apparatus.

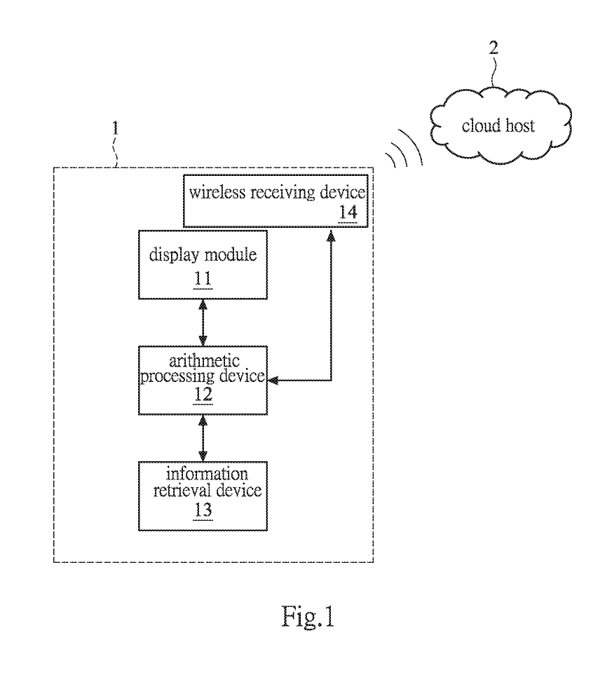

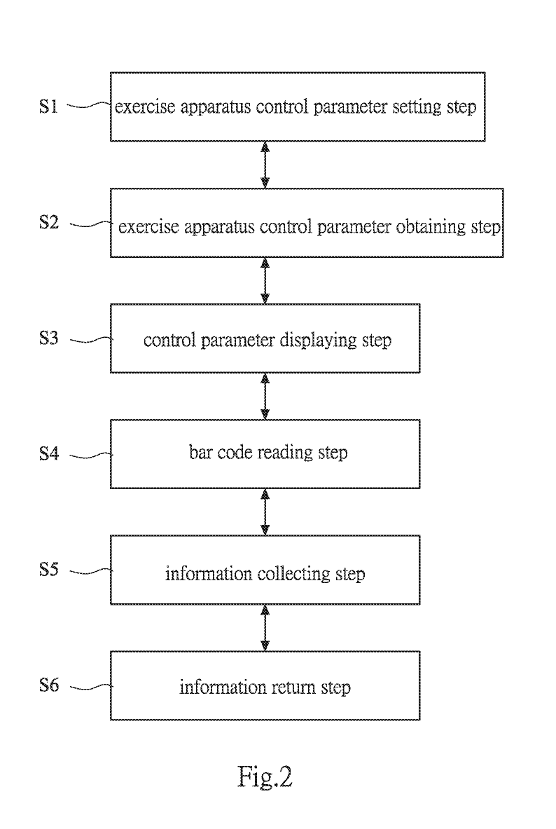

As shown in FIG. 1 and FIG. 2, the method of the present invention relates to a mobile exercise apparatus control method. A mobile exercise apparatus controller 1 is provided to communicate with a cloud host 2 via the Internet. The mobile exercise apparatus controller 1 can obtain an exercise apparatus control parameter set in the cloud host 2 to perform a setting operation for an exercise apparatus 3. The method comprises:

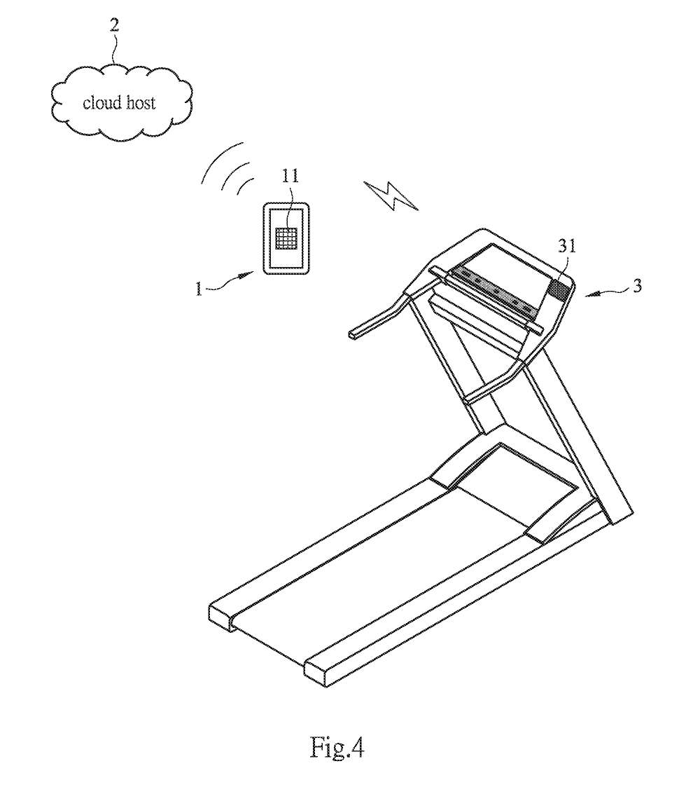

An exercise apparatus control parameter setting step S1: A coach user (coach 1 to coach n as shown in FIG. 4) sends a control parameter to the cloud host 2 via the Internet. Wherein, each coach user may transmit the setting value to the cloud host 2 through a mobile device, a computer, or any device that can input the setting value via a direct signal connection, or the Internet, or an operating application installed in the mobile device, or a designated input webpage.

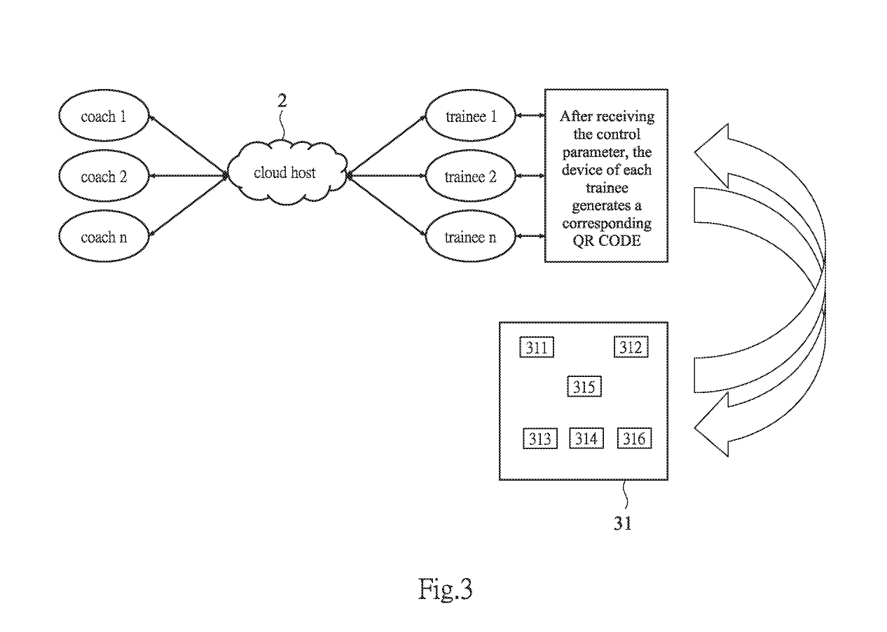

An exercise apparatus control parameter obtaining step S2: An operator (trainee 1 to trainee n as shown in FIG. 3) uses a mobile exercise apparatus controller 1 to communicate with the cloud host 2 and download a corresponding control parameter via the Internet. The control parameter may be a corresponding condition for controlling the damping or the rotational speed or the weight of the exercise apparatus. The control parameter may be an equation that changes with time (i.e., generating a different damping or rotational speed or weight to coordinate time), thereby achieving the effect of scenarios simulation.

A control parameter displaying step S3: The mobile exercise apparatus controller 1 converts the obtained control parameter into a bar code and displays it on a display module 11 of the mobile exercise apparatus controller. The bar code may be a two-dimensional bar code or a QR code or any format able to complete data transmission via image recognition.

A bar code reading step S4: After an information transmission collection device 31 coupled to or communicated with the exercise apparatus 3 performs reading, the read control parameter (text) or a video can be displayed on a display unit 314 communicated with the information transmission collection device 31, or the obtained control parameter after reading may be transmitted to the exercise apparatus 3 communicated with the information transmission collection device 31 for performing the setting of the exercise apparatus 3 in accordance with the control parameter. Wherein, the operation instruction explanation or the operation video can be played when the read control parameter is displayed. The contents are pre-stored in a storage unit provided in the information transmission collection device. The user performs the operation setting according to the control parameter. For example, when the exercise apparatus 3 is a treadmill, the control parameter may include time, speed, and the like. As another example, when the exercise apparatus 3 is a flywheel exercise pedaling machine, the control parameter may include damping, time, etc. Furthermore, the control parameter may further include operation instructions of a plurality of exercise apparatuses 3, that is, when the user completes the operation of a designated exercise apparatus, he/she will perform the operation of a second exercise apparatus according to the instructions.

Furthermore, the method may comprise an information collecting step S5: The information transmission collection device 31 coupled to the exercise apparatus 3 obtains or receives the operation data of the exercise apparatus 3, and then the operation data is converted into a bar code and displayed on a display unit 314 connected with the information transmission collection device 31. Wherein, the display unit 314 may be replaced with a printing unit to print the bar code directly for a user (trainee) to perform reading. The bar code may be a two-dimensional bar code or a QR code or any format able to complete data transmission via image recognition.

Furthermore, the method may comprise an information return step S6: After an information retrieval device 13 connected with the mobile exercise apparatus controller 1 performs data reading, the data is transmitted back to the cloud host 2 through a wireless receiving device 14. The coach user can confirm the operation situation of the trainee via the cloud database and give appropriate advice or plan follow-up courses.

The embodiment of the present invention can be used for the coach and the trainee to carry out the course, through the way of data transmission to complete the required parameter control or the teaching of the control parameter setting to achieve the purpose of fitness training. This can prevent the user from operating mistakenly, resulting in that the expected effect cannot be achieved. Further, when the exercise apparatus controller transmits information to the information transmission collection device 31, the information transmission collection device 31 can interpret the information to confirm whether or not the control information is the exercise apparatus communicated with the information transmission collection device 31. If it is correct, the user continues to use the exercise apparatus. If it is not correct, it will send a warning image or sound to remind the operator.

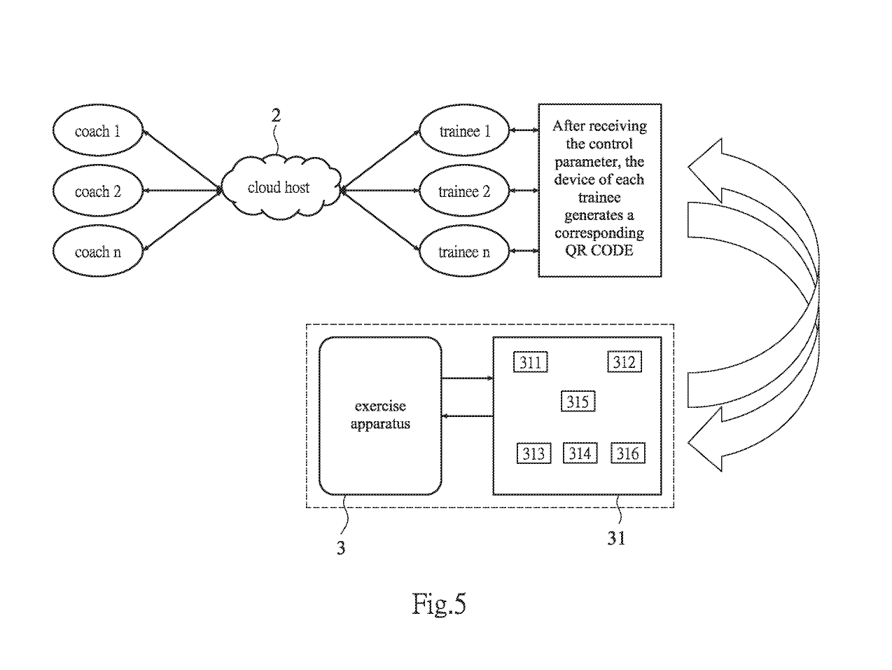

As shown in FIG. 5, when the information transmission collection device 31 is in communication with the exercise apparatus and the user's exercise is completed, the exercise apparatus 3 will convert the operation data during exercise into a format for data transmission (such as, a bar code), and then the data is transmitted back to the mobile exercise apparatus controller 1 and the operation data is transmitted to the cloud host 2. This way can simplify the input operations for the user and avoid data misunderstanding due to input errors. Through the operation data returned to the cloud host 2, the coach can understand the exercise status of the user and analyze and plan the next training for the user. A coach may guide and train several trainees at the same time. Furthermore, the data of parameter setting of the cloud host 2 will be downloaded to the mobile exercise apparatus controller 1 of each trainee (user) to generate a corresponding two-dimensional bar code or QR code or any other code able to be read and recognized, improving efficiency and accuracy. Therefore, the method of the embodiment of the present invention facilitates the planning of using the exercise apparatus for the coach and the trainee and simplifies the setting operations to overcome the problems of the prior art.

As shown in FIG. 1, in order to achieve the above-described method, this embodiment provides a mobile exercise apparatus controller 1. The mobile exercise apparatus controller 1 comprises a display module 11, an arithmetic processing device 12, an information retrieval device 13, and a wireless receiving device 14. The display module 11, the information retrieval device 13 and the wireless receiving device 14 are electrically connected with the arithmetic processing device 12 for performing the aforesaid method. The mobile exercise apparatus controller 1 may be a customized device or a mobile device (e.g., a smartphone, a tablet, or a wearable device). After a corresponding application is installed or a corresponding webpage is opened, the operations for displaying the bar code or reading the bar code can be completed according to the steps. The information retrieval device may be a two-dimensional bar code scanner or an image retrieval device.

As shown in FIG. 4, this embodiment also discloses an exercise apparatus 3 coupled with an information transmission collection device. The exercise apparatus 3 is not limited to the type disclosed in the drawings. Any exercise apparatus able to perform parameter setting via an electronic signal can be used as the exercise device 3 described in this embodiment.

Further, as described above, the information transmission collection device 31 coupled to the exercise apparatus may include a bar code reading unit 311, an encoding unit 313, a display unit 314, and a data processor 315. The bar code reading unit 311, the encoding unit 313 and the display unit 314 are communicated with the data processor 315. The bar code reading unit 311 may be a two-dimensional bar code scanner or a lens device.

After the bar code reading unit 311 reads a bar code, the data processor 315 performs a decoding operation to obtain the parameter control data and display it on the display unit 314 for the user to watch and operate. The content for watching may be illustrated with characters or a video. The parameter control data may be transmitted to a data transmission unit 312 communicated with the data processor 315. The data transmission unit 312 transmits the parameter control data to an exercise apparatus 3 communicated with the data transmission unit 312, so that the exercise apparatus 3 can perform the setting of the corresponding parameters according to the parameter control data. Wherein, the operation instruction explanations or the operation video may be pre-stored in a storage unit (not shown in the drawings) communicated with the data processor 315.

After using the exercise apparatus, the recorded data during use is retrieved or received through the data transmission unit 312 to the encoding unit 313, the encoding unit generates a return bar code and displays it on the display unit 314 for reading of the corresponding device. Wherein, the information transmission collection device 31 may further comprise a connecting device 316 communicated with the exercise apparatus 3 through a signal cable.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An exercise apparatus control method, a mobile exercise apparatus controller being provided to communicate with a cloud host via Internet, the mobile exercise apparatus controller being configured to obtain an exercise apparatus control parameter set in the cloud host, the method comprising:
an exercise apparatus control parameter setting step, a coach user transmitting a control parameter to the cloud host via the Internet;
an exercise apparatus control parameter obtaining step, an operator using the mobile exercise apparatus controller to communicate with the cloud host and download the corresponding control parameter via the Internet;
a control parameter displaying step, the mobile exercise apparatus controller converting the obtained control parameter into a bar code and displaying it on a display module of the mobile exercise apparatus controller;
a bar code reading step, an information transmission collection device being provided for performing reading, the information transmission collection device transmitting the control parameter to the exercise apparatus communicated with the information transmission collection device for performing setting, or a display unit connected with the information transmission collection device displaying a plurality of operation instruction explanations or an operation video for the operator, the operation instruction explanations or the operation video being pre-stored in a storage unit provided in the information transmission collection device.

2. The exercise apparatus control method as claimed in claim 1, further comprising:
an information collecting step, the information transmission collection device communicated with the exercise apparatus obtaining or receiving operation data of the exercise apparatus and then the operation data being converted into a bar code and displayed on the display unit connected with the information transmission collection device of the exercise apparatus;
an information return step, an information retrieval device communicated with the mobile exercise apparatus controller performing data reading and transmitting it back to the cloud host.

3. A mobile exercise apparatus controller, comprising a display module, an arithmetic processing device, an information retrieval device, and a wireless receiving device, the display module, the information retrieval device and the wireless receiving device being electrically connected with the arithmetic processing device for performing the following steps of:
the wireless receiving device being communicated with a cloud host via Internet for downloading at least one exercise apparatus control parameter corresponding to a user;
the arithmetic processing means converting the exercise apparatus control parameter into a data format and displaying it on the display module; and
the information retrieval device being used to read a bar code.

4. The mobile exercise apparatus controller as claimed in claimed 3, wherein the data format is a two-dimensional bar code, a QR code, or a format able to complete data transmission via image recognition.

5. An exercise apparatus, communicated with an information transmission collection device, wherein,
the information transmission collection device includes a bar code reading unit, a data transmission unit, an encoding unit, and a display unit, the bar code reading unit, the data transmission unit, the encoding unit and the display unit are communicated with a data processor;
the bar code reading unit is used to read a bar code and perform decoding to obtain control data, the control data is transmitted to the data transmission unit, the data transmission unit transmits the control data to the exercise apparatus so that the exercise apparatus can perform a setting of a corresponding parameter according to the control data or the parameter is displayed on the display unit;
after the exercise apparatus is used, recorded data during use is retrieved or received through the data transmission unit to the encoding unit, the encoding unit generates a return bar code for reading of a corresponding device.

6. The exercise apparatus as claimed in claim 5, wherein the display unit is replaced with a printing unit for printing the bar code directly.

7. The exercise apparatus as claimed in claim 6, wherein the data processor is communicated with a storage unit, and the storage unit is pre-stored with a plurality of operation instruction explanations or an operation video.

8. An information transmission collection device coupled to an exercise apparatus, comprising a bar code reading unit, an encoding unit, and a display unit, the bar code reading unit, the encoding unit and the display unit being communicated with a data processor;
the bar code reading unit being used to read a bar code and perform decoding to obtain control data, the control data being displayed on the display unit or transmitted to a data transmission unit communicated with the data processor; wherein when the control data is transmitted to the data transmission unit, the data transmission unit transmits the control data to the exercise apparatus so that the exercise apparatus can perform a setting of a corresponding parameter according to the control data; after the exercise apparatus is used, recorded data during use is retrieved or received through the data transmission unit to the encoding unit, the encoding unit generates a return bar code for reading of a corresponding device.

9. The information transmission collection device as claimed in claim 8, wherein the display unit is replaced with a printing unit for printing the bar code directly.

10. The information transmission collection device as claimed in claim 9, wherein the data processor is communicated with a storage unit, and the storage unit is pre-stored with a plurality of operation instruction explanations or an operation video.
